(19) United States
(12) Patent Application Publication
(10) Pub. No.: US 2007/0064740 A1
(43) Pub. Date: Mar. 22, 2007

(54) Device, system and method of clock synchronization

(76) Inventor: Shai Waxman, Haifa (IL)

Correspondence Address: PEARL COHEN ZEDEK LATZER, LLP, 1500 BROADWAY, 12TH FLOOR, NEW YORK, NY, 10036, US

(21) Appl. No.: 11/228,253

(22) Filed: Sep. 19, 2005

(51) Int. Cl. H04J 3/00

(52) U.S. Cl. 370/498

(57) ABSTRACT

Some embodiments of the invention provide devices, systems and methods of clock synchronization. For example, a system in accordance with an embodiment of the invention includes a wireless access point to transmit a signal instructing a plurality of wireless communication stations to substantially simultaneously transmit wireless signals at a pre-defined time; and a wireless communication station including a synchronizer to synchronize, at a non allocated time slot, a clock of the wireless communication station to a clock of the wireless access point based on an estimated frequency offset of a data packet received from the wireless access point.

### BACKGROUND OF THE INVENTION

In the field of wireless communications, a first wireless communication station may communicate, for example, with a second wireless communication station or a. wireless access point. The first and second stations and the access point may include a clock, for example, to allow execution of certain transmitting and/or receiving operations at pre-defined time intervals.

Some applications may require a precise synchronization between the clock of the first station and the clock of the access point and/or the second station. Such applications may include, for example, Spatial Diversity Multiple Access (SDMA) applications, in which multiple wireless stations transmit data simultaneously to a Multiple Input Multiple Output (MIMO) wireless access point, and applications utilizing combined duplexing techniques, e.g., Time-Division Duplex (TDD) combined with Carrier Sense Multiple Access (CSMA) to meet a high Quality of Service (QoS) data streaming requirement.

Unfortunately, the clocks of the first station, the second station and/or the access point may not be synchronized and may suffer from drifting. Furthermore, the Institute of Electrical and Electronics Engineers (IEEE) 802.11 standard does not provide a mechanism to synchronize these clocks.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic block diagram illustration of a wireless communication system able to perform clock synchronization in accordance with an embodiment of the invention;

FIG. 2 is a schematic block diagram illustration of a receiver path and a transmitter path in accordance with an embodiment of the invention; and

FIG. 3 is a schematic flow-chart of a method of clock synchronization in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, units and/or circuits have not been described in detail so as not to obscure the invention.

Embodiments of the invention may be used in a variety of applications. Some embodiments of the invention may be used in conjunction with many apparatuses and systems, for example, a transmitter, a receiver, a transceiver, a transmitter-receiver, a wireless communication station, a wireless communication device, a wireless Access Point (AP), a modem, a wireless modem, a personal computer, a desktop computer, a mobile computer, a laptop computer, a notebook computer, a Personal Digital Assistant (PDA) device, a tablet computer, a server computer, a network, a wireless network, a Local Area Network (LAN), a Wireless LAN (WLAN), devices and/or networks operating in accordance with existing IEEE 802.11, 802.11a, 802.11b, 802.11e, 802.11g, 802.11 h, 802.11i, 802.11n standards and/or future versions of the above standards, a Personal Area Network (PAN), a Wireless PAN (WPAN), units and/or devices which are part of the above WLAN and/or PAN and/or WPAN networks, a Basic Service Set (BSS) or a device thereof, an Extended Service Set (ESS) or a device thereof, one way and/or two-way radio communication systems, cellular radio-telephone communication systems, a cellular telephone, a wireless telephone, a Personal Communication Systems (PCS) device, a PDA device which incorporates a wireless communication device, a Multiple Input Multiple Output (MMO) transceiver or device, a Single Input Multiple Output (SIMO) transceiver or device, a Multiple Input Single Output (MISO) transceiver or device, a Multi Receiver Chain (MRC) transceiver or device, a transceiver or device having “smart antenna” technology or multiple antenna technology, or the like. Some embodiments of the invention may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), Extended GPRS, Code-Division Multiple Access (CDMA), Wideband CDMA (WCDMA), CDMA 2000, Multi-Carrier Modulation (MDM), or the like. Embodiments of the invention may be used in various other apparatuses, devices, systems and/or networks.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, parameters, or the like. For example, “a plurality of stations” may include two or more stations.

Although portions of the discussion herein may relate, for demonstrative purposes, to synchronizing a clock of a wireless communication station to a clock of a wireless Access Point (AP), embodiments of the invention are not limited in this regard. For example, a clock of the wireless communication station may be synchronized to a clock of other suitable wireless devices, e.g., a second wireless communication station, a fixed AP, a floating AP, a wireless communication station operating as an AP, or the like.

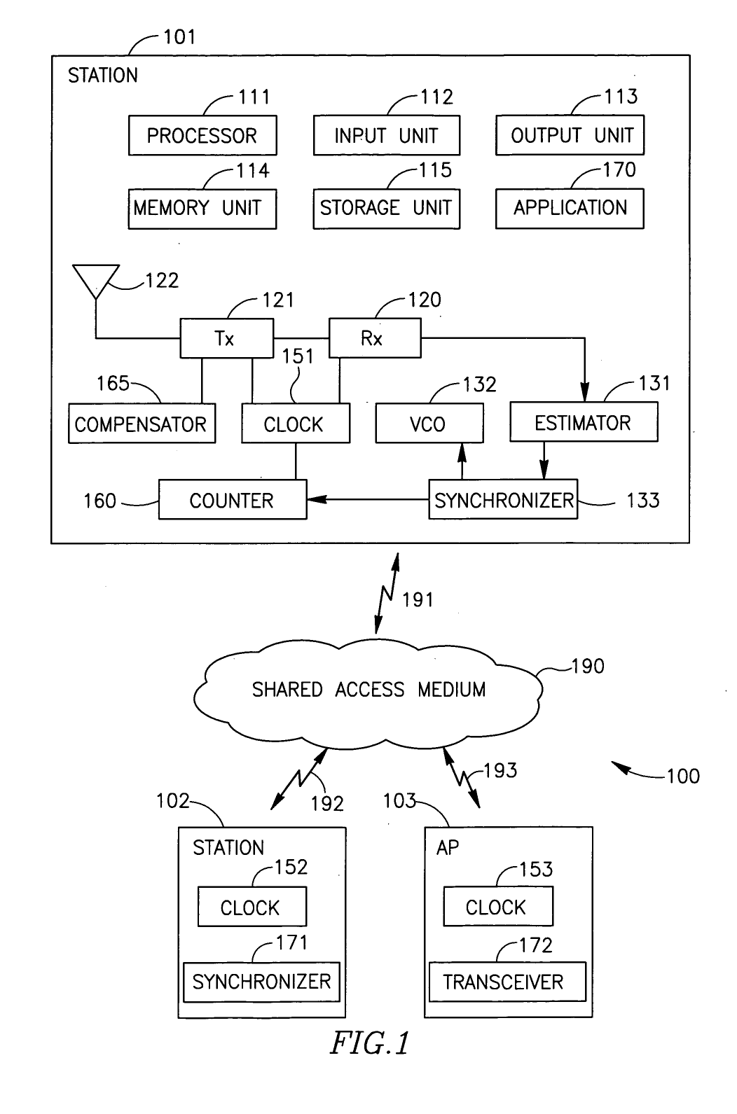

FIG. 1 schematically illustrates a block diagram of a wireless communication system 100 able to perform clock synchronization in accordance with an embodiment of the invention. System 100 may include one or more wireless communication stations, e.g., stations 101 and 102, and one or more wireless access points, e.g., Access Point (AP) 103. Station 101, station 102 and AP 103 may communicate using a shared access medium 190, for example, through wireless communication links 191, 192 and 193, respectively. In some embodiments, AP 103 may optionally be a wireless MIMO access point able to substantially simultaneously communicate, for example, using a wireless MIMO. transceiver 172, with multiple wireless communication devices, e.g., with stations 101 and 102.

In some embodiments, system 100 may be or may include an a-synchronic wireless network or an asynchronous wireless network, e.g., in accordance with 802.11 standard. In one embodiment, system 100 may optionally be or may include a hybrid wireless network, for example, having one or more components able to operate in accordance with a first wireless communication standard (e.g., 802.11 standard) and one or more components able to operate in accordance with a second wireless communication standards (e.g., 802.16).

Station 101 may include, for example, a processor 111, an input unit 112, an output unit 113, a memory unit 114, a storage unit 115, a receiver 120, a transmitter 121, and an antenna 122. Station 101 may further include other hardware components and/or software components.

Processor 111 may include, for example, a Central Processing Unit (CPU), a Digital Signal Processor (DSP), a microprocessor, a controller, a chip, a microchip, an Integrated Circuit (IC), or any other suitable multi-purpose or specific processor or controller.

Input unit 112 may include, for example, a keyboard, a keypad, a mouse, a touch-pad, a microphone, or other suitable pointing device or input device. Output unit 113 may include, for example, a Cathode Ray Tube (CRT) monitor or display unit, a Liquid Crystal Display (LCD) monitor or display unit, a speaker, or other suitable monitor or display unit or output device.

Memory unit 114 may include, for example, a Random Access Memory (RAM), a Read Only Memory (ROM), a Dynamic RAM (DRAM), a Synchronous DRAM (SD-RAM), a Flash memory, a volatile memory, a non-volatile memory, a cache memory, a buffer, a short term memory unit, a long term memory unit, or other suitable memory units or storage units.

Storage unit 115 may include, for example, a hard disk drive, a floppy disk drive, a Compact Disk (CD) drive, a CD-ROM drive, or other suitable removable or non-removable storage units.

Transmitter 121 may include, for example, a wireless Radio Frequency (RF) transmitter able to transmit RF signals, e.g., through antenna 122. Receiver 120 may include a wireless RF receiver able to receive RF signals, e.g., through antenna 122.

In some embodiments, the functionality of transmitter 121 and receiver 120 may be implemented in the form of a transceiver, a transmitter-receiver, or one or more units able to perform separate or integrated functions of transmitting and/or receiving wireless communication signals, blocks, frames, transmission streams, packets, messages and/or data.

Antenna 122 may include an internal and/or external RF antenna, for example, a dipole antenna, a monopole antenna, an omni-directional antenna, an end fed antenna, a circularly polarized antenna, a micro-strip antenna, a diversity antenna, or any other type of antenna suitable for transmitting and/or receiving wireless communication signals, blocks, frames, transmission streams, packets, messages and/or data.

In some embodiments, optionally, an application 170 may be executed by one or more components of station 101, for example, by processor 111. The application 170 may include, for example, a software application, an Operating System (OS), a communications driver, a communication software, or the like, and may be stored in memory unit 114 and/or storage unit 115.

Station 101 may further include a clock 151, which may provide timing data to one or more components of station 101. Similarly, station 102 may include a clock 152 able to provide timing data to one or more components of station 102, and AP 103 may include a clock 153 able to provide timing data to one or more components of AP 103.

In accordance with some embodiments of the invention, receiver 120 of station 101 may receive an incoming wireless communication signal, e.g., transmitted by AP 103. The wireless signal may include, for example, one or more data packets. Station 101 may perform frequency estimation, for example, using an estimator 131. This may include, for example, estimation of an offset of the frequency of one or more data packets received from AP 103. In one embodiment, optionally, the frequency offset estimation may be performed based on multiple data packets received from AP 103, e.g., to increase frequency offset estimation accuracy.

In some embodiments, for example, the estimated frequency offset may be relatively small, e.g., smaller than approximately 5 KHz, approximately one Part Per Million (PPM), or approximately two percent of a subcarrier frequency gap (e.g., approximately two percent of 312.5 KHz).

In relation to the estimated frequency offset, a synchronizer 133 may synchronize the clock 151 of station 101 to the clock 153 of AP 103. This may be performed, for example, by tuning a reference Voltage Controlled Oscillator (VCO) 132 of station 101, e.g., implemented using a Phase Locked Loop (PLL), a Digital PLL (DPLL), a fractional-N PLL, or the like. The synchronization may include, for example, modifying or tuning a control word or a digital control word of the VCO 132, thereby allowing VCO 132 to generate a precise frequency.

In some embodiments, station 101 may substantially couple its clock 151 and frequency, e.g., in accordance with 802.11a standard or 802.11g standard clock/frequency coupling; therefore, a relatively small estimated frequency offset may allow station 101 to achieve a relatively accurate synchronization between clock 151 of station 101 and clock 153 of AP 153, e.g., such that the clocks 151 and 153 may be approximately one PPM apart or less than one PPM apart.

In some embodiments, the above operations may be repeated, for example, at pre-defined time intervals, to tune and/or fine-tune the VCO 132. For example, in one embodiment, the above operations may be performed upon receiving a beacon signal, e.g., at time intervals of approximately 100 milliseconds.

In some embodiments, a digital implementation may be used to synchronize the clock 151 of station 101 to the clock 153 of AP 103, e.g., based on the estimated frequency offset. For example, station 101 may include one or more timers or counters 160 operatively associated with clock 151. The counters 160 may be biased, delayed or advanced, for example, by one or more counting units counting units, to compensate for the estimated frequency offset and to synchronize the counters 160 to the clock 153 of AP 103. For example, the counting rate of counter 160 may be C Hz, the estimated frequency offset may be D PPM, and counter 160 may be biased by one counting unit every Y cycles, wherein Y may be the product of C multiplied by D. For example, for example, if the counting rate of counter 160 is 160 MHz, and the estimated frequency offset is 10 PPM, then counter 160 may be biased by one counting unit after 1,600 cycles, or every 1600 cycles, since the product of 160,000,000 and 10/1,000,000 is 1,600.

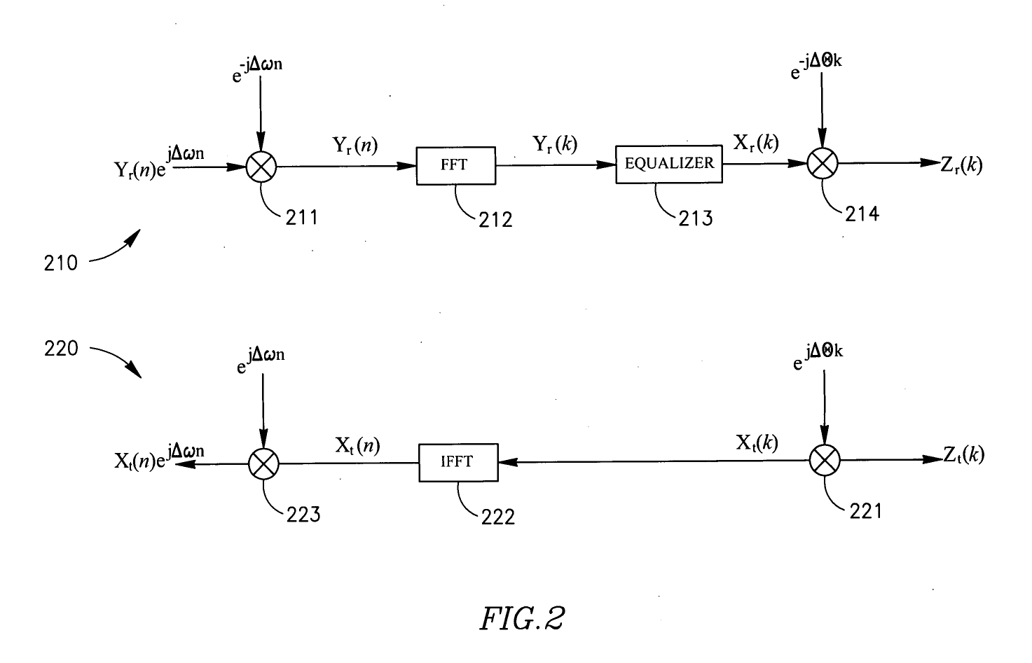

In some embodiments, the transmission frequency of station 101 may be shifted or compensated by the estimated frequency offset, for example, to allow transmitter 121 to transmit at a frequency substantially identical or substantially equal to the frequency of AP 103. This may be performed using a compensator 165, for example, a corrector, an extrapolator or an interpolator similar to an interpolator utilized by a receiver to correct a frequency mismatch, e.g., as described herein with reference to FIG. 2.

In some embodiments, station 101 may transmit to AP 103 a signal or message indicating that station 101 is able to perform clock synchronization in accordance with embodiments of the invention, and/or a signal or message indicating that station 101 is able to transmit at a frequency substantially identical to the frequency of the AP 103. This may allow AP 103 to avoid one or more acquisition operations, e.g., frequency estimation of an incoming signal transmitted by station 101.

In some embodiments, station 102 may be similar or substantially identical to station 101, and thus may be able to synchronize its clock 152 to the clock 153 of AP 103, and/or to transmit data to AP 103 at a frequency substantially identical to the frequency of the AP 103. This may further allow station 101 and 102 to transmit data substantially simultaneously, to begin data transmission at substantially the same time, to create and utilize a synchronized delay period between station 101 and 102, to transmit data at precise time intervals or after a synchronized delay period elapses, or the like.

In some embodiments, clock 151 of station 101 may be synchronized to the clock 153 of AP 103 although AP 103 may transmit data packets at non pre-defined time intervals, at pseudo-random times, at non allocated time(s) or time slot(s), or at non-predicted time(s), e.g., in accordance with 802.11 standards. For example, clock 151 may be synchronized at non pre-defined time(s), at non allocated time(s) or time slot(s), at non pre-determined time(s) or intervals, at random or pseudo-random time(s), or the like.

In some embodiments, clocks of multiple stations, e.g., station 101 and station 102, may be synchronized to the clock of AP 103. In one embodiment, this may allow, for example, station 101 and station 102 to transmit data at substantially the same time, or after a pre-defined time period elapses. For example, stations 101 and 102 may synchronize their clocks to the clock of station 103, and may, after a time period elapses, transmit data substantially simultaneously.

In some embodiments, station 101 may selectively synchronize its clock 151 to match a clock of a certain other wireless device, for example, clock 153 of AP 103, and not necessarily clock 152 of station 102. For example, station 101 may receive a data packet and may determine that the data packet was transmitted by AP 103, e.g., based on a MAC parameter or MAC address, and may synchronize the clock 151 based on an estimated frequency offset of the received data packet. Conversely, station 101 may determine that the data packet was transmitted by station 102, and may avoid synchronizing clock 151 based on the received data packet.

In some embodiments, clock synchronization may be performed non-periodically, at random time(s), at pseudo-random time(s), on a burstable basis, at non allocated time(s) or time slot(s), at non pre-defined times, or the like. For example, in one embodiment, clock 151 of station 101 may be synchronized to clock 153 of AP 153 at pseudo-random or non-periodic times, or at non allocated time(s) or time slot(s), e.g., upon receiving a data packet from AP 103. In some embodiments, for example, system 100 may utilize open-loop synchronization or non closed-loop synchronization, e.g., such that synchronization of clock 151 to clock 153 may be performed at non-periodic times, non pre-defined times, at non allocated time(s) or time slot(s), pseudo random time(s), times separated by different or pseudo-random intervals, or the like.

Although portions of the discussion herein may relate, for demonstrative purposes, to synchronization of clock 151 to clock 153, other time-related components, time measurement components or clock-related components of station 101 may be synchronized to clock 153 of AP 103. For example, in one embodiment, one or more counters 160 of station 101 may be synchronized to clock 153 of AP 103.

In some embodiments, station 101 may use synchronizer 133 to synchronize clock 151 to clock 153 of AP 103; similarly, station 102 may use a synchronizer 171 to synchronize clock 152 to clock 153 of AP 103. In one embodiment, this may be performed in response to a synchronization instruction broadcasted or transmitted by AP 103.

In some embodiments, AP 103 may broadcast or transmit an instruction, e.g., to both station 101 and station 102, instructing them to transmit signals or data at a certain time, exactly at a certain time, or after waiting a certain time period. Clocks 151 and 152 may be synchronized to clock 153, stations 151 and 152 may receive the instruction and may thus transmit signals or data substantially simultaneously at the instructed time or after the instructed time period elapses.

FIG. 2 is a schematic block diagram illustration of a receiver path 210 and a transmitter path 220 in accordance with an embodiment of the invention. For example, receiver path 210 may be part of receiver 120 of FIG. 1, and transmitter path 220 may be part of transmitter 121 or compensator 165 of FIG. 1.

Receiver path 210 may carry a stream of symbols in the time domain n, which may be represented as Yᵣ(n)e^{jΔωn}. The stream of symbols may be multiplied using a scaler 211 by a time domain phasor, which may be represented as e^{-jΔωn}, to compensate for a possible time offset and to result in a time-domain scaled stream of symbols represented as Yᵣ(n). A Fast Fourier Transform (FFT) unit 212 may perform a FFT on the time-domain scaled stream of symbols, to result in a stream of symbols in the frequency domain k, which may be represented as Yᵣ(k). The stream of symbols in the frequency domain may be equalized by an equalizer 213, to result in a stream of equalized symbols represented as Xᵣ(k). The equalized stream of symbols may be multiplied using a scaler 214 by a frequency domain phasor, which may be represented as e^{-jΔθk}, to compensate for a possible sampling time drift and to result in a frequency-domain scaled stream of equalized symbols represented as Zᵣ(k).

Transmitter path 220 may carry a stream of symbols in the frequency domain k, which may be represented as Zₜ(k). The stream of symbols may be multiplied using a scaler 221 by a frequency domain phasor, which may be represented as e^{jΔθk}, to compensate for a possible sampling time drift and to result in a frequency-domain scaled stream of symbols represented as Xₜ(k). An Inverse FFT (IFFT) unit 222 may perform an inverse FFT on the frequency-domain scaled stream of symbols, to result in a stream of symbols in the time domain n, which may be represented as Xₜ(n). The stream of symbols in the time domain may be multiplied using a scaler 223 by a time domain phasor, which may be represented as e^{jΔωn}, to compensate for a possible time offset and to result in a time-domain scaled stream of symbols represented as Xₜ(n)e^{jΔωn}.

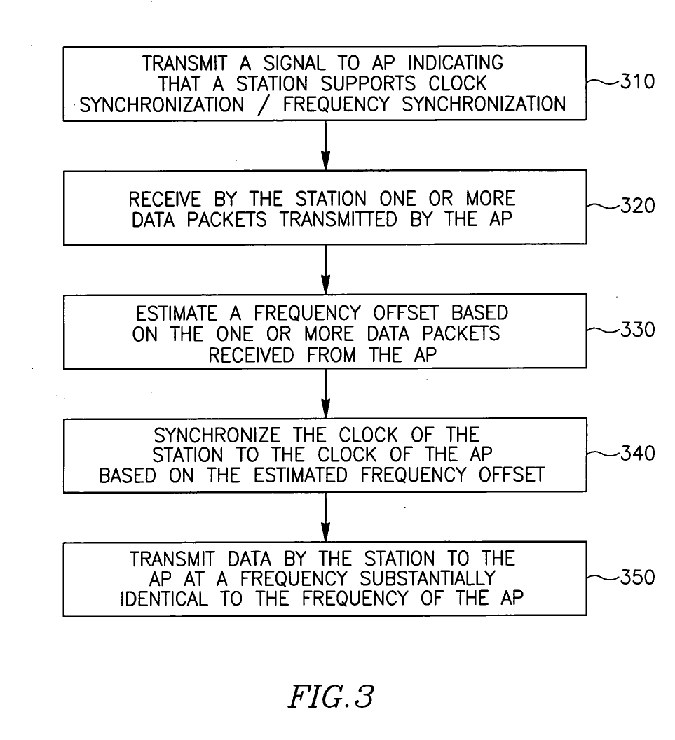

FIG. 3 is a schematic flow-chart of a method of clock synchronization in accordance with an embodiment of the invention. Operations of the method may be implemented, for example, by system 100 of FIG. 1, by station 101 of FIG. 1, by station 102 of FIG. 1, by AP 103 of FIG. 1, by processor 111 of FIG. 1, and/or by other suitable stations, access points, controllers, receivers, transmitters, processors, synchronizers, units, devices, and/or systems.

As indicated at box 310, the method may optionally include, for example, transmitting a signal, e.g., by station 101 to AP 103, indicating that station 101 supports clock synchronization and/or frequency synchronization in accordance with embodiments of the invention. This may allow AP 103 to avoid one or more acquisition operations, e.g., frequency estimation of an incoming signal transmitted by station 101.

As indicated at box 320, the method may include, for example, receiving by station 101 one or more data packets transmitted by AP 103. This may be performed, for example, at a non pre-defined time, at random or pseudo random time(s) or interval(s), at non allocated time(s) or time slot(s), at arbitrary or non-predicted time(s), or the like.

As indicated at box 330, the method may include, for example, estimating a frequency offset based on the one or more data packets received from AP 103.

As indicated at box 340, the method may include, for example, synchronizing the clock 151 of station 101 to the clock 153 of AP 103, e.g., based on the estimated frequency offset. In one embodiment, for example, the synchronization may include tuning the VCO 132 or modifying a control word of the VCO 132. In another embodiment, for example, the synchronization may include biasing, delaying or advancing one or more counters 160 operatively associated with the clock 151.

As indicated at box 350, the method may include, for example, transmitting data by the station 101 to AP 103 at a frequency substantially identical to the frequency of AP 103. In one embodiment, this may include, for example, modifying, tuning, or setting the transmission frequency of station 101 to match the frequency of AP 103. In another embodiment, for example, modified or interpolated data may be transmitted by station 101 using unmodified transmission frequency, e.g., resulting in transmission of data at the frequency of AP 103.

In some embodiments, optionally, one or more of the above operations may be repeated, for example, at pre-defined time intervals, at approximately 100 milliseconds intervals, upon receiving of a beacon signal, or the like.

In some embodiments, optionally, other suitable operations may be performed. For example, multiple stations may synchronize their clocks to the clock of the AP 103, may transmit data at substantially the same time, may utilize a synchronized delay period, or the like.

Other suitable operations or sets of operations may be used in accordance with embodiments of the invention.

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, stacks, storage units and/or memory units, for temporary or long-term storage of data or in order to facilitate the operation of a specific embodiment.

Some embodiments of the invention may be implemented, for example, using a machine-readable medium or article which may store an instruction or a set of instructions that, if executed by a machine, for example, by system 100 of FIG. 1, by station 101 of FIG. 1, by station 102 of FIG. 1, by access point 103 of FIG. 1, by processor 1 11 of FIG. 1, or by other suitable machines, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit (e.g., memory unit 114 or storage unit 115), memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A wireless communication system comprising:
a wireless access point to transmit a signal instructing a plurality of wireless communication stations to substantially simultaneously transmit wireless signals at a pre-defined time; and
a wireless communication station including a synchronizer to synchronize, at a non allocated time slot, a clock of the wireless communication station to a clock of the wireless access point based on an estimated frequency offset of a data packet received from the wireless access point.

2. The wireless communication system of claim 1, wherein the wireless communication station comprises:
an estimator to estimate the frequency offset and to provide the frequency offset to the synchronizer.

3. The wireless communication system of claim 1, wherein said synchronizer is to tune a Voltage Controlled Oscillator of the wireless communication station based on said estimated frequency offset.

4. The wireless communication system of claim 1, wherein said synchronizer is to bias a counter associated with the clock of said wireless communication station based on said first estimated frequency offset.

5. The wireless communication system of claim 1, wherein said wireless communication station comprises:
a transmitter to transmit data to said wireless access point at a transmission frequency substantially equal to a frequency of said wireless access point based on said estimated frequency offset.

6. The wireless communication system of claim 1, wherein said wireless communication station comprises:
a compensator to compensate said estimated frequency offset by modifying data intended for transmission based on said estimated frequency offset; and
a transmitter to transmit the modified data to said wireless access point.

7. The wireless communication system of claim 6, wherein said compensator comprises:
a first scaler to multiply a symbol in a frequency domain by a frequency domain compensation phasor; and
a second scaler to multiply a symbol in a time domain by a time domain compensation phasor.

8. The wireless communication system of claim 1, wherein said wireless access point comprises:
a wireless Multiple Input Multiple Output transceiver able to substantially simultaneously communicate with said plurality of wireless communication stations.

9. The wireless communication system of claim 1, wherein said plurality of wireless communication devices are to synchronize a plurality of internal clocks, respectively, and to substantially simultaneously transmit a plurality of wireless signals at said pre-defined time.

10. A wireless communication station comprising:
a synchronizer to synchronize, at a non allocated time slot, a clock of the wireless communication station to a clock of a wireless access point based on an estimated frequency offset of a data packet received from the wireless access point, in response to a signal received from said wireless access point instructing said wireless communication station and another wireless communication station to substantially simultaneously transmit wireless signals at a pre-defined time.

11. The wireless communication station of claim 10, further comprising:
an estimator to estimate the frequency offset and to provide the frequency offset to the synchronizer.

12. The wireless communication station of claim 10, wherein said synchronizer is to tune a Voltage Controlled Oscillator of said wireless communication station based on said estimated frequency offset.

13. The wireless communication station of claim 10, wherein said synchronizer is to bias a counter associated with said clock of said wireless communication station based on said estimated frequency offset.

14. The wireless communication station of claim 10, further comprising:
a transmitter to transmit data to said wireless access point at a transmission frequency substantially equal to a frequency of said wireless access point based on said estimated frequency offset.

15. The wireless communication station of claim 10, further comprising:
a compensator to compensate said estimated frequency offset by modifying data intended for transmission based on said estimated frequency offset; and
a transmitter to transmit the modified data to said wireless access point.

16. The wireless communication station of claim 10, further comprising:
a compensator to compensate said estimated frequency offset by modifying data intended for transmission based on said estimated frequency offset; and
a transmitter to transmit the modified data to said wireless access point.

17. The wireless communication station of claim 16, wherein said compensator comprises:
a first scaler to multiply a symbol in a frequency domain by a frequency domain compensation phasor; and
a second scaler to multiply a symbol in a time domain by a time domain compensation phasor.

18. A method comprising:
receiving a signal instructing a plurality of wireless communication stations to substantially simultaneously transmit wireless signals at a pre-defined time; and
synchronizing, at a non allocated time slot, a clock of a wireless communication station to a clock of a wireless access point based on an estimated frequency offset of a data packet received from the wireless access point.

19. The method of claim 18, further comprising:
estimating the frequency offset; and
providing the frequency offset to the synchronizer.

20. The method of claim 18, comprising:
tuning a Voltage Controlled Oscillator of said wireless communication station based on said estimated frequency offset.

21. The method of claim 18, wherein synchronizing comprises:
biasing a counter associated with the clock of said wireless communication station based on said estimated frequency offset.

22. The method of claim 18, further comprising:
transmitting data to said wireless access point at a transmission frequency substantially equal to a frequency of said wireless access point based on said estimated frequency offset.

23. The method of claim 18, further comprising:
compensating said estimated frequency offset by modifying data intended for transmission based on said estimated frequency offset; and
transmitting the modified data to said wireless access point.

24. The method of claim 23, wherein compensating comprises:
multiplying a symbol in a frequency domain by a frequency domain compensation phasor; and
multiplying a symbol in a time domain by a time domain compensation phasor.

25. A wireless communication station comprising:
a dipole antenna to receive wireless communication signals; and
a synchronizer to synchronize, at a non allocated time slot, a clock of the wireless communication station to a clock of a wireless access point based on an estimated frequency offset of a data packet received from the wireless access point, in response to a signal received from said wireless access point instructing said wireless communication station and another wireless communication station to substantially simultaneously transmit wireless signals at a pre-defined time.

26. The wireless communication station of claim 25, further comprising:
an estimator to estimate the frequency offset and to provide the frequency offset to the synchronizer.

27. The wireless communication station of claim 25, wherein said synchronizer is to tune a Voltage Controlled Oscillator of said wireless communication station based on said estimated frequency offset.
